(19) United States
(12) Patent Application Publication
(10) Pub. No.: US 2005/0105293 A1
(43) Pub. Date: May 19, 2005

(54) Lamp shade

(76) Inventor: Kevin Hsu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/714,993

(22) Filed: Nov. 17, 2003

(51) Int. Cl. F21V 1/06

(52) U.S. Cl. 362/352; 362/357; 362/358

(57) ABSTRACT

A lamp shade includes a shade, and a support structure mounted in the shade for supporting the shade. The support structure includes a first ring fixed on a first end of the shade, a second ring fixed on a second end of the shade, and an elastic member mounted between the first ring and the second ring. Thus, the lamp shade is folded when not in use so as to reduce the volume of the lamp shade, thereby facilitating package, storage and transportation of the lamp shade, and thereby decreasing the costs of transportation.

### BACKGROUND OF THE INVENTION

1. Field of the Invention

The present invention relates to a lamp shade, and more particularly to a lamp shade that can be folded when not in use, so as to reduce the volume of the lamp shade, thereby facilitating package, storage and transportation of the lamp shade, and thereby decreasing the costs of transportation.

2. Description of the Related Art

A conventional lamp shade 1 in accordance with the prior art shown in FIG. 5 comprises an upper ring 11, a lower ring 12, and a plurality of ribs 13 mounted between the upper ring 11 and the lower ring 12. The upper ring 11 has a mounting rack 111 for mounting a lamp, such as a table lamp.

However, the ribs 13 are fixed between the upper ring 11 and the lower ring 12 by soldering, so that the conventional lamp shade 1 has a fixed volume and cannot be folded, thereby causing inconvenience in package, storage and transportation of the conventional lamp shade 1, and thereby increasing costs of package and transportation.

### SUMMARY OF THE INVENTION

The primary objective of the present invention is to provide a lamp shade that can be folded when not in use, so as to reduce the volume of the lamp shade, thereby facilitating package, storage and transportation of the lamp shade, and thereby decreasing the costs of package and transportation.

Another objective of the present invention is to provide a lamp shade that can be assembled and disassembled easily and conveniently, thereby facilitating the user assembling and disassembling the lamp shade.

In accordance with the present invention, there is provided a lamp shade, comprising:
a shade; and
a support structure mounted in the shade for supporting the shade, the support structure including:
a first ring fixed on a first end of the shade;
a second ring fixed on a second end of the shade; and
an elastic member mounted between the first ring and the second ring.

Further benefits and advantages of the present invention will become apparent after a careful reading of the detailed description with appropriate reference to the accompanying drawings.

### BRIEF DESCRIPTION OF THE DRAWINGS

FIG. 1 is a plan cross-sectional view of a lamp shade in accordance with the preferred embodiment of the present invention;

FIG. 2 is a schematic perspective view showing the lamp shade being mounted on a table lamp;

FIG. 3 is a schematic plan assembly view showing the lamp shade being mounted on the table lamp;

FIG. 4 is a perspective folded view of the lamp shade in accordance with the preferred embodiment of the present invention; and

FIG. 5 is a perspective view of a conventional lamp shade in accordance with the prior art.

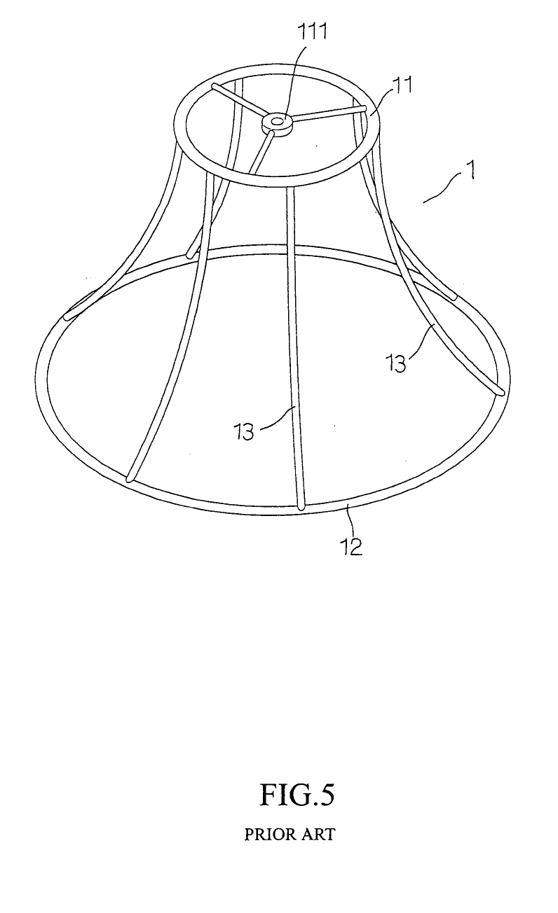

### DETAILED DESCRIPTION OF THE INVENTION

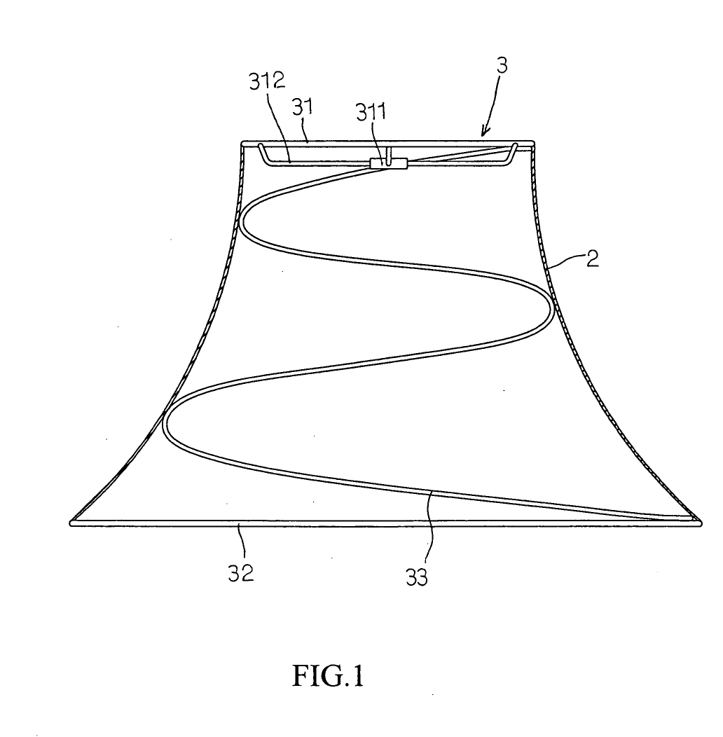

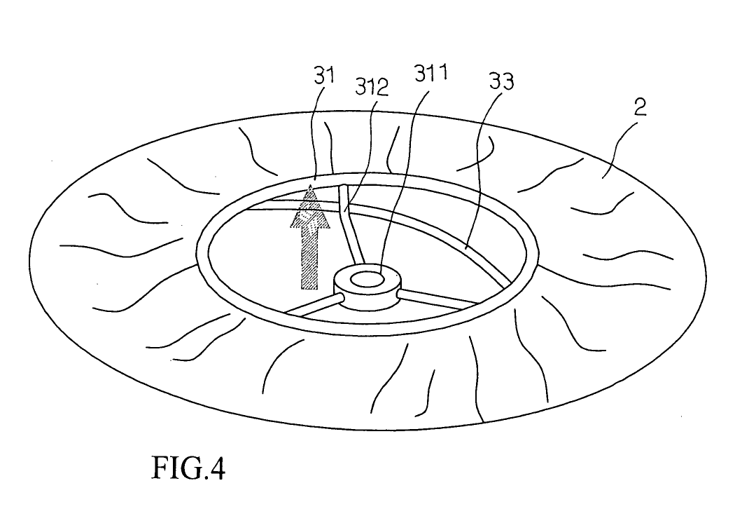

Referring to the drawings and initially to FIGS. 1 and 4, a lamp shade in accordance with the preferred embodiment of the present invention comprises a shade 2, and a support structure 3 mounted in the shade 2 for supporting the shade 2.

The shade 2 is made of flexible material, such as cloth or the like.

The support structure 3 is foldable as shown in FIG. 4 and includes a first ring 31 fixed on a first end of the shade 2, a second ring 32 fixed on a second end of the shade 2, and an elastic member 33 mounted between the first ring 31 and the second ring 32.

The first ring 31 of the support structure 3 has a periphery provided with a plurality of substantially L-shaped support bars 312 and has a central portion provided with a support portion 311 supported by the support bars 312.

The elastic member 33 of the support structure 3 has a substantially helical shape and has a first end secured to the first ring 31 by soldering and a second end secured to the second ring 32 by soldering. The elastic member 33 of the support structure 3 has a periphery rested on an inner periphery of the shade 2 to expand of the shade 2 as shown in FIG. 1. In addition, the elastic member 33 is folded between the first ring 31 and the second ring 32 as shown in FIG. 4 when the first ring 31 is pressed toward the second ring 32.

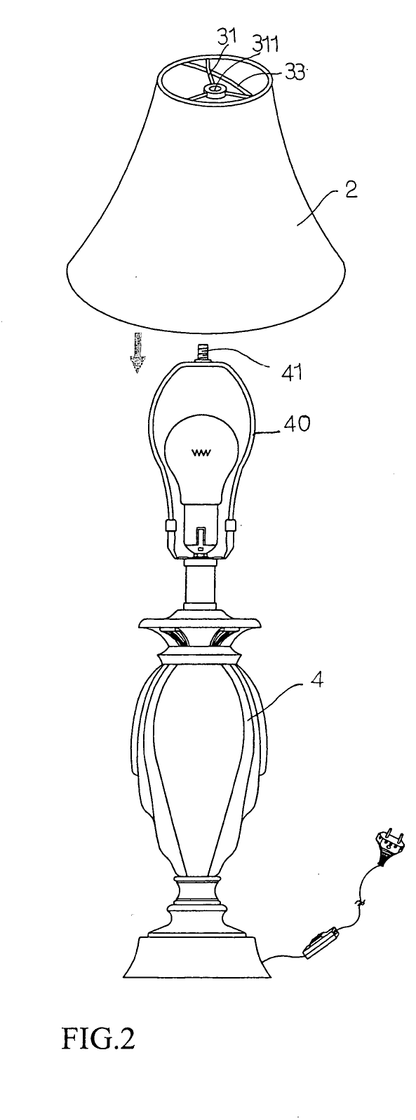

In assembly, referring to FIGS. 1-3, the first ring 31 is pulled upward to release the elastic member 33, so that the elastic member 33 springs upward. At this time, the elastic member 33 is stretched between the first ring 31 and the second ring 32 by its restoring force, and the elastic member 33 has a periphery rested on the inner periphery of the shade 2 so as to expand and stretch the shade 2, so that the lamp shade is fully developed as shown in FIG. 1.

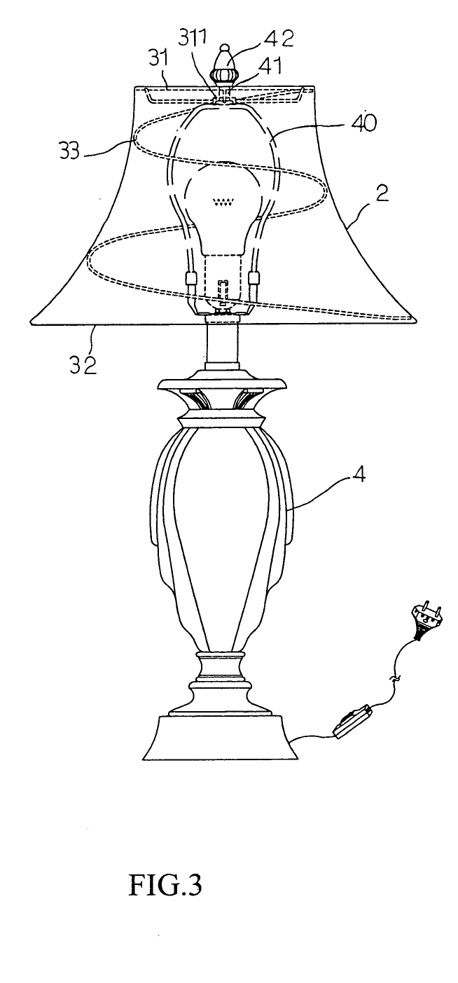

Subsequently, the expanded lamp shade is mounted on a table lamp 4. The table lamp 4 includes a harp 40 mounted in the shade 2 and rested on the bottom of the support portion 311 of the first ring 31, a threaded rod 41 mounted on the harp 40 and extended through the support portion 311 of the first ring 31, and a decorative nut 42 screwed on the threaded rod 41 and rested on the top of the support portion 311 of the first ring 31, so that the expanded lamp shade is mounted on the table lamp 4 as shown in FIG. 3.

Alternatively, the decorative nut 42 is unscrewed from the threaded rod 41 to detach the support portion 311 of the first ring 31 from the threaded rod 41 of the harp 40, so that the expanded lamp shade can be removed from the table lamp 4.

Subsequently, the first ring 31 is pressed toward the second ring 32 to compress and fold the elastic member 33, so that the elastic member 33 is folded between the first ring 31 and the second ring 32 as shown in FIG. 4 so as to fold the shade 2, thereby folding the lamp shade.

Accordingly, the lamp shade is assembled and disassembled easily and conveniently, thereby facilitating the user assembling and disassembling the lamp shade. In addition, the lamp shade can be fully folded when not in use, so as to reduce the volume of the lamp shade, thereby facilitating package, storage and transportation of the lamp shade, and thereby decreasing costs of package and transportation.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lamp shade, comprising:
a shade; and
a support structure mounted in the shade for supporting the shade, the support structure including:
a first ring fixed on a first end of the shade;
a second ring fixed on a second end of the shade; and
an elastic member mounted between the first ring and the second ring.

2. The lamp shade in accordance with claim 1, wherein the shade is made of flexible material.

3. The lamp shade in accordance with claim 1, wherein the shade is made of cloth.

4. The lamp shade in accordance with claim 1, wherein the support structure is foldable.

5. The lamp shade in accordance with claim 1, wherein the elastic member of the support structure has a substantially helical shape.

6. The lamp shade in accordance with claim 1, wherein the elastic member of the support structure has a first end secured to the first ring and a second end secured to the second ring.

7. The lamp shade in accordance with claim 1, wherein the elastic member of the support structure has a periphery rested on an inner periphery of the shade to expand of the shade.

8. The lamp shade in accordance with claim 1, wherein the elastic member of the support structure is folded between the first ring and the second ring when the first ring is pressed toward the second ring.

9. The lamp shade in accordance with claim 1, wherein the elastic member of the support structure springs toward the first ring and the second ring when the first ring is pulled outward relative to the second ring.

10. The lamp shade in accordance with claim 1, wherein the first ring of the support structure has a periphery provided with a plurality of support bars.

11. The lamp shade in accordance with claim 10, wherein each of the support bars of the first ring is substantially L-shaped.

12. The lamp shade in accordance with claim 10, wherein the first ring of the support structure has a central portion provided with a support portion supported by the support bars.
